(19) United States
(12) Patent Application Publication
(10) Pub. No.: US 2022/0381636 A1
(43) Pub. Date: Dec. 1, 2022

(54) A TESTING SYSTEM

(71) Applicant: Safe Gauge Pty Ltd, New South Wales (AU)

(72) Inventors: Steven Chick, New South Wales (AU); Luke Dawson, New South Wales (AU)

(21) Appl. No.: 17/770,962

(22) PCT Filed: Oct. 25, 2019
(86) PCT No.: PCT/AU2019/051173

§ 371 Date: Apr. 21, 2022

(51) Int. Cl. G01L 19/08; H04W 4/38

(52) U.S. Cl. CPC G01L 19/086; H04W 4/38

(57) ABSTRACT

A pressure testing system (10) includes a plurality of pressure sensors (16) and a user interface (14). Each pressure sensor (16) includes a housing (20), a pressure transducer (18) to measure pressure and convert the measured pressure to pressure data, a sensor storage module (76) containing a unique identifier of the pressure sensor (16), a sensor communications module (32) for transmitting identifier data and the pressure data, and a representation (19) of the unique identifier carried on an external surface of the housing (20). The user interface (14) includes an interface storage module (112) containing a library of the unique identifiers, an interface communications module (114) for receiving the transmitted identifier data and pressure data, and a controller (110) for identifying the selected pressure sensor (16) and for confirming that that pressure sensor (16) is associated with the user interface (14) by matching the unique identifiers.

### TECHNICAL FIELD

The present disclosure relates, generally, to testing physical parameters, and, more particularly, to a pressure testing system and to a method of testing pressure.

### BACKGROUND

Pressure sensors are used in the trucking, mining and general machinery industries to measure and test extremely high oil pressures for various pieces of equipment. Technicians using these pressure sensors are prone to serious injury or death in the case of a malfunction which may cause the pressurised oil to come into contact with a technician.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

In an aspect of the present disclosure, there is provided a pressure testing system, comprising: a plurality of pressure sensors, each pressure sensor, comprising: a housing mountable to an item, the pressure of which is to be measured; a pressure transducer arranged in the housing to measure pressure and convert the measured pressure to pressure data; a sensor storage module arranged in the housing, the sensor storage module containing a unique identifier of the pressure sensor; a sensor communications module in communication with the pressure transducer for transmitting identifier data and the pressure data; and a representation of the unique identifier carried on an external surface of the housing; and a user interface, comprising: an interface storage module containing a library of the unique identifiers of the pressure sensors associated with the user interface; an interface communications module which communicates wirelessly with the sensor communications module of each pressure sensor for receiving the transmitted identifier data and pressure data from a selected one of the pressure sensors; and a controller which communicates with each pressure sensor via the interface communications module and the sensor communications module of the selected sensor for identifying the selected pressure sensor and for confirming that that pressure sensor is associated with the user interface by matching the unique identifiers stored in the sensor storage module of the selected pressure sensor and in the interface storage module of the user interface.

Each pressure sensor may further comprise a sensor controller for controlling operation of the sensor communications module to send the pressure data after a connection has been established with the interface communications module. The sensor communications module may be operable, by the sensor controller, to provide access to the unique identifier of the sensor storage module for the interface communications module to read the unique identifier for determining that the unique identifier of the selected pressure sensor matches one of the unique identifiers stored in the interface storage module to establish the connection with the sensor communications module. The controller of the user interface may be configured to operate the interface communications module to read the unique identifier of the sensor storage module of the selected pressure sensor to determine that the unique identifier of the selected pressure sensor matches one of the unique identifiers stored in the interface storage module to establish the connection with the sensor communications module. Each pressure sensor may further comprise an annunciator controlled by the sensor controller for indicating operational status of the pressure sensor.

The system described above may use a Bluetooth protocol as a communications protocol between the each sensor communications module of each pressure sensor and the user interface, the sensor communications module thus being a Bluetooth module and the interface communications module also being a Bluetooth module.

The user interface may further comprise a display on which information is displayed to a user.

The system described above may include a carrier defining a plurality of receptacles for receiving the pressure sensors and the user interface, each pressure sensor and the user interface being received in their respective receptacles. The carrier may house a store of electrical power and in which each receptacle has an electrical terminal associated with it for supplying electrical power to each pressure sensor and the user interface when the pressure sensors and the user interface are contained in their respective receptacles.

In another aspect of the present disclosure, there is provided a method of testing pressure, the method comprising: mounting a pressure sensor to an item, the pressure of which is to be measured, the pressure sensor being configured to measure pressure and convert the measured pressure into pressure data and the pressure sensor having a unique identifier associated with it, the unique identifier being electronically stored within the pressure sensor and being represented on an external surface of the pressure sensor; interrogating the mounted pressure sensor using a user interface which communicates wirelessly with the pressure sensor, the user interface interrogating the pressure sensor to determine its unique identifier; comparing the unique identifier of the pressure sensor with a library of unique identifiers stored in a storage module of the user interface; and if the unique identifier of the interrogated pressure sensor matches one of the unique identifiers in the library of the user interface, establishing a communications link to obtain the measured pressure data from the interrogated pressure sensor.

The method may include associating a plurality of pressure sensors with the user interface, each pressure sensor having its own unique identifier stored electronically and a representation of which is carried on the external surface of the pressure sensor, the method further comprising storing each of the unique identifiers in an interface storage module of the user interface. The method may include selecting which of the pressure sensors to use and, prior to mounting any one of the pressure sensors to the item, checking that the representation of the unique identifier of each selected pressure sensor matches the unique identifier stored in the interface storage module of the user interface. The method may include displaying the pressure measured by each pressure sensor on a display of the user interface. The method may include displaying a minimum pressure and a maximum pressure measured by each pressure sensor on the display of the user interface.

The method may include storing the sensors and the user interface in a carrier and providing electrical power to the sensors and the user interface via the carrier. The method may include indicating an operational status of each pressure sensor via an annunciator carried by the pressure sensor. Each pressure sensor and the user interface may communicate with each other via a Bluetooth protocol.

In yet another aspect of the present disclosure, there is provided a pressure sensor for use with the pressure testing method described above, the pressure sensor comprising: a housing mountable to an item, the pressure of which is to be measured; a pressure transducer arranged in the housing to measure pressure and convert the measured pressure to pressure data; a sensor storage module arranged in the housing, the sensor storage module containing a unique identifier of the pressure sensor; a sensor communications module in communication with the pressure transducer for transmitting identifier data and the pressure data; and a representation of the unique identifier carried on an external surface of the housing.

In yet another aspect of the present disclosure, there is provided a user interface for use with the pressure testing method described above, the user interface comprising: an interface storage module containing a library of unique identifier of each a plurality of pressure sensors associated with the user interface; an interface communications module which communicates wirelessly with the sensor communications module of each pressure sensor for receiving transmitted identifier data and pressure data from a selected one of the pressure sensors; and a controller which communicates with each pressure sensor via the interface communications module and the sensor communications module of the selected sensor for identifying the selected pressure sensor and for confirming that that pressure sensor is associated with the user interface by matching the unique identifiers stored in the sensor storage module of the selected pressure sensor and in the interface storage module of the user interface.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure will now be described by way of example only with reference to the accompanying drawings in which:

FIG. 1 shows a perspective view of an embodiment of a pressure testing system;

FIG. 2 shows a perspective view of a pressure sensor for use with the pressure testing system shown in FIG. 1;

FIG. 3 shows a perspective view of the pressure sensor shown in FIG. 2 with a housing of the sensor removed;

FIG. 4 shows a front view of a user interface for use with the pressure testing system shown in FIG. 1;

FIG. 5 shows a block diagram of the pressure sensor shown in FIGS. 2 and 3;

FIG. 6 shows a block diagram of the user interface shown in FIG. 4;

FIG. 7 shows a flow chart of an embodiment of the operation of the pressure sensor;

FIG. 8 shows a software schematic of the user interface shown in FIG. 4; and

FIG. 9 shows an embodiment of a method of testing pressure.

### DETAILED DESCRIPTION OF EXEMPLARY EMBODIMENTS

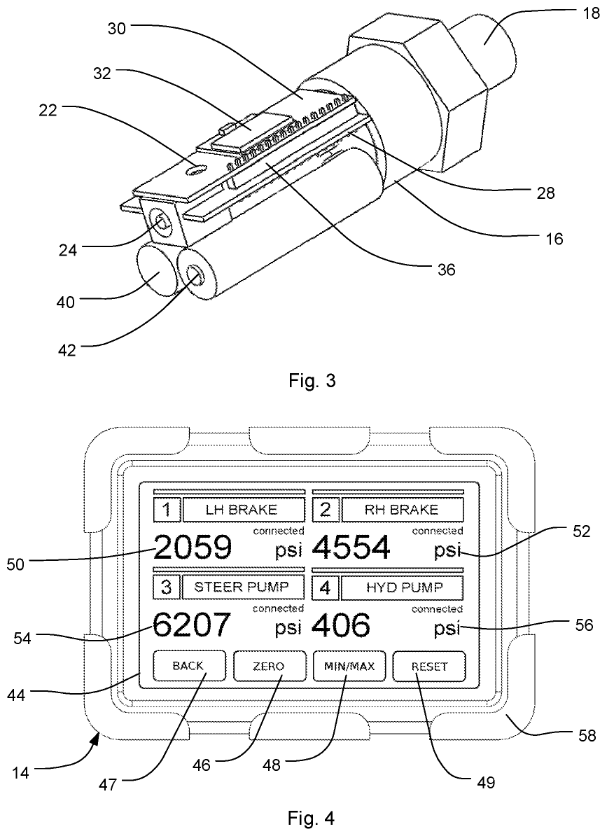

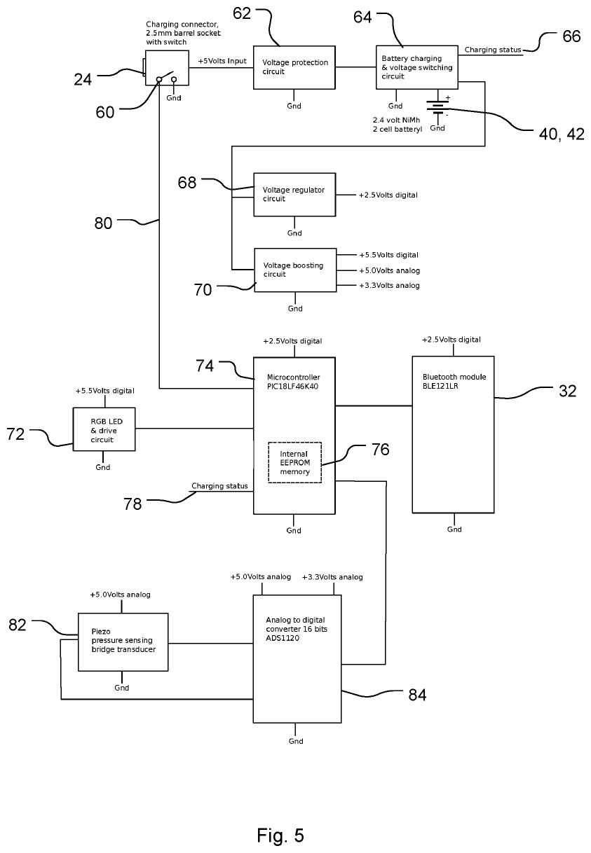

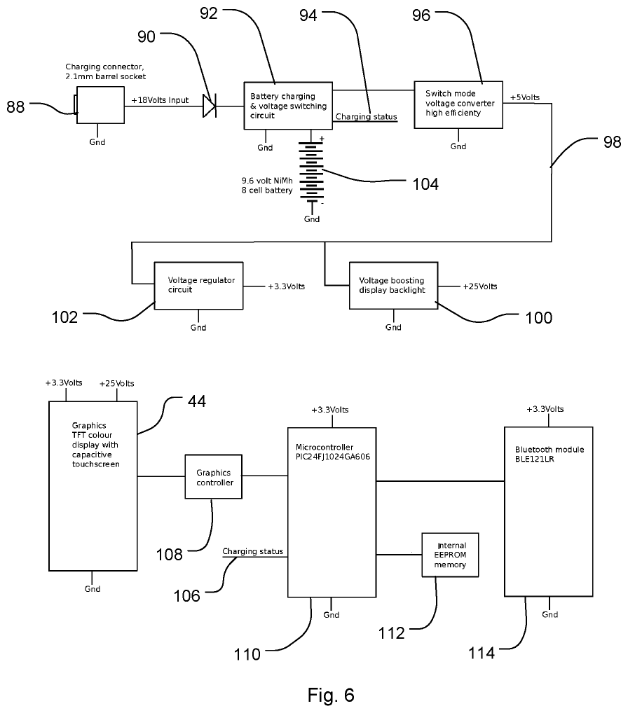

In the drawings, reference numeral 10 generally designates an embodiment of a pressure testing system. The pressure testing system 10 includes a plurality of pressure sensors 16. Each pressure sensor 16 includes a housing 20 mountable to an item (not shown), the pressure of which is to be measured. Each pressure sensor 16 further includes a pressure transducer 18 arranged in the housing 20 to measure pressure and convert the measured pressure to pressure data. Each pressure sensor 16 further includes a sensor communications module 32 (FIG. 3) in communication with the pressure transducer 18 for transmitting the pressure data. Each pressure sensor 16 further includes a sensor storage module 76 (FIG. 5) arranged in the housing 20, the sensor storage module 76 containing a unique identifier of the pressure sensor 16. Each pressure sensor 16 further includes a representation 19 of the unique identifier carried on an external surface of the housing 20. The pressure testing system 10 further includes a user interface 14, which includes an interface storage module 112 (FIG. 6) containing a library of the unique identifiers of pressure sensors 16 associated with the user interface 14. The user interface 14 also includes an interface communications module 114 which communicates wirelessly with the sensor communications module 32 of each pressure sensor 16 for receiving the transmitted pressure data from a selected one of the pressure sensors 16. The user interface 14 further includes a controller 110 which communicates with each pressure sensor 16 via the interface communications module 114 and the sensor communications module 32 of the selected sensor 16 for identifying the selected pressure sensor 16 and for confirming that that pressure sensor 16 is associated with the user interface 14 by matching the unique identifiers stored in the sensor storage module 76 of the selected pressure sensor 16 and in the interface storage module 112 of the user interface 14.

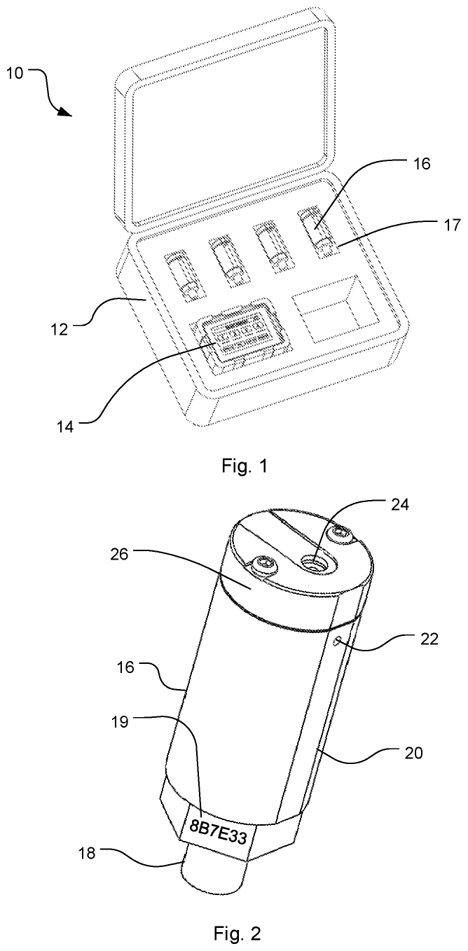

As illustrated in FIG. 1, the plurality of pressure sensors 16 and the user interface 14 of the system 10 are received in a carrier, in the form of a case, 12 for storage and charging when not in use. The case 12 defines a plurality of receptacles 17 for receiving the pressure sensors 16 and the user interface 14, with each pressure sensor 16 and the user interface 14 being received in their respective receptacles 17 when not in use. The case 12 houses a store of electrical power (not shown) and each receptacle 17 has an electrical terminal associated with it for supplying electrical power to each pressure sensor 16 and the user interface 14 when the pressure sensors 16 and the user interface 14 are contained in their respective receptacles 17.

As illustrated more clearly in FIGS. 2 and 3, each pressure sensor 16 includes a pressure transducer 18, a power adapter input 24, and an annunciator in the form of a light emitting diode (LED) 22. The pressure sensor also includes a housing 20 and housing cap 26 which protect the internal components of the pressure sensor 16. These internal components include a communications circuit board 30 carrying the sensor communications module 32, a circuit board 28 carrying various internal, electronic components shown in FIG. 6, rechargeable batteries 40, 42 connected to the power adapter input 24 and an inter board connector 36 extending between and connecting the communications circuit board 30 and the circuit board 28.

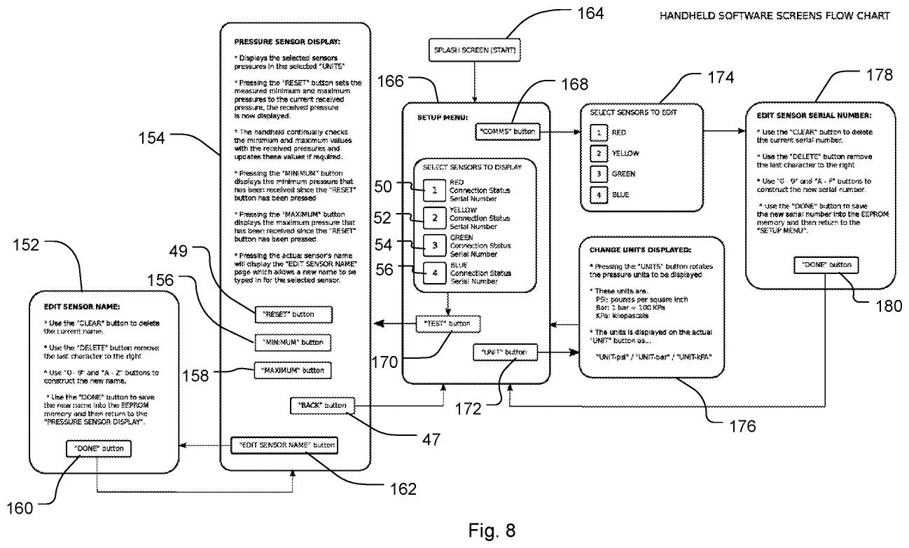

The user interface 14 includes a housing 58 having a display 44 on which information is displayed to a user. The display 44 shows four connected pressure sensors 16 displayed as connector indications 50, 52, 54, 56 and navigation buttons BACK 47, ZERO 46, Min/Max 48 and RESET 49. Thus it will be appreciated that the display 44 is a haptic display, or touch screen display. The functions of these navigation buttons are discussed in greater detail below with reference to FIG. 8.

In the circuit block diagram illustrated in FIG. 5, the components of the pressure sensor 16 are shown in greater detail. The pressure transducer 18 includes a piezoelectric pressure sensing bridge transducer 82 to measure pressure and an analog to digital converter 84 to convert the pressure measured by the transducer 82 to digital pressure data.

The pressure transducer 18 is connected via the A/D converter 84 to a sensor controller 74 which stores the pressure data in the sensor storage module 76. The storage module 76 is embodied in the form of an electrically erasable programmable read-only memory (EEPROM) storage module. The sensor controller 74 also controls operation of the sensor communications module 32, in the form of a Bluetooth module, to send the pressure data and the unique identifier after a connection has been established with the interface communications module 114 (FIG. 6) as will be described in greater detail below.

The power adapter input 24 is connected to a voltage protection unit 62 and a battery charging and voltage switching circuit 64 which controls the charge of the rechargeable batteries 40, 42. The battery charging and voltage switching circuit 64 also outputs a charging status 66 received as a charging status 78 at the controller 74 to indicate to the controller 74 that the batteries 40, 42 are being charged. The charging status 66 is also displayed to the user via the LED 22. A drive circuit 72 for the LED 22, is also connected to, and controlled by, the sensor controller 74.

The battery charging and voltage switching circuit 64 is also connected to a voltage regulator circuit 68 and a voltage boosting circuit 70 which are also connected to each other. The voltage regulator circuit 68 provides a 2.5V digital output to the sensor controller 74 and the Bluetooth module 32. The voltage boosting circuit 70 provides a 5.5V digital output to the drive circuit 72, a 5V analog output to the transducer 82 and to the A/D converter 84 and a 3.3V analog output to the A/D converter 84.

The power adapter input 24 is operable to deliver charging power to the rechargeable batteries 40, 42 via the voltage protection circuit 62 and the charging and voltage switching circuit 64. When a switch 60 of the power adapter input 24 is in a closed configuration, it indicates to the sensor controller 74 (via a connection 80) that the sensor 16 is in use. While the pressure sensor 16 is charging in the receptacle 17 of the case 12, the switch 60 will be in an open configuration as illustrated in FIG. 5, indicating to the sensor controller 74 that power is being delivered from the power adapter unit 24 to the rechargeable batteries 40, 42. The power adapter input 24, voltage protection circuit 62, battery charging and voltage switching circuit 64, voltage regulator circuit 68, voltage boosting circuit 70, sensor controller 74, sensor storage module 76 and drive circuit 72 are carried by the circuit board 28.

In the circuit block diagram illustrated in FIG. 6, the components of the user interface 14 are shown in greater detail. An interface controller 110 is connected to, and controls, the interface communications module 114 which is in the form of a Bluetooth module, and a graphics controller 108. The graphics controller 108 is connected to, and controls, the display 44.

Thus, in this embodiment, the system 10 uses a Bluetooth protocol as a communications protocol between each sensor communications module 32 of each pressure sensor 16 and the interface communications module 114 of the user interface 14, since both the sensor communications module 32 and the interface communications module 114 are Bluetooth modules. Specifically, the interface controller 110 is configured to operate the interface communications module 114 to read the unique identifier of the sensor storage module 76 of the selected pressure sensor 16 to determine that the unique identifier stored in each sensor storage module 76 of each selected pressure sensor 16 matches one of the unique identifiers stored in the interface storage module 112 to establish a connection with the sensor communications module 32 of each sensor 16.

Those skilled in the art will appreciate that other communications protocols could be used in appropriate circumstances such as, for example, infrared communication, or other wireless communications protocols.

The interface controller 110 also outputs a charging status 106 to indicate to a user whether the user interface 14 is low on power. The interface controller 110 also stores a library of unique identifiers in the connected interface storage module 112, which is embodied in the form of an EEPROM storage module.

A charging connector 88 is provided which allows voltage to pass through and charge a battery 104 via a diode 90 and a battery charging and voltage switching circuit 92. The battery charging and voltage switching circuit 92 also outputs a charging status 94 to indicate to a user that the battery 104 is being charged, and is also connected to a switch mode voltage converter 96. The switch mode voltage converter 96 is connected to a voltage regulator circuit 102 and a voltage booster 100. The voltage regulator circuit 102 provides a voltage (3.3V) to each of the display 44, the interface module 110 and the Bluetooth module 114. The voltage booster 100 provides a higher voltage (25V) to a backlight (not shown) of the display 44, which are also connected to each other.

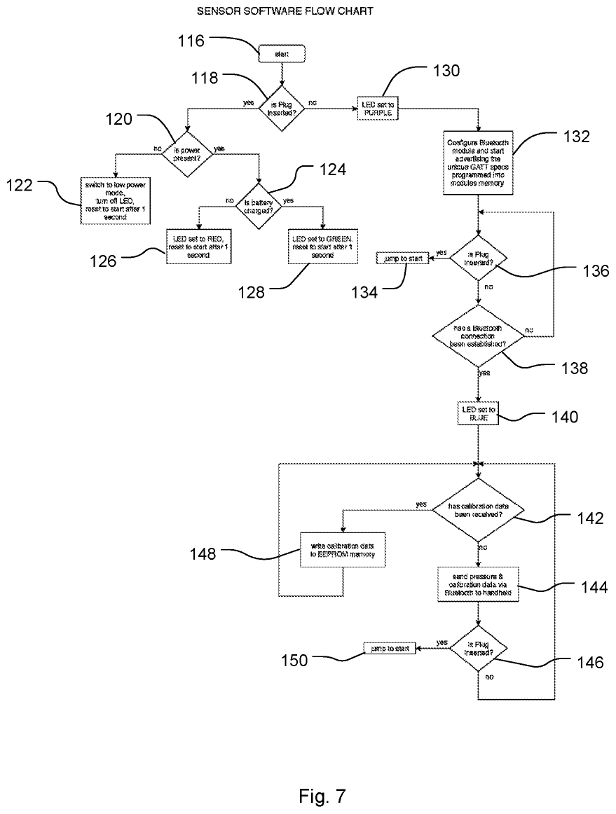

Operation of the sensor 16 is now described in greater detail with reference to FIG. 7. From a start state 116, the sensor controller 74 carries out a charging determination procedure at 118 to check whether or not a charging plug is inserted into the power adapter input 24, i.e. whether or not the sensor 16 is in its receptacle 17 in the case 12. If a determination is made that the charging plug is inserted in the power adapter input 24, the sensor controller 74 places the sensor 16 in a charging configuration and a power determination procedure is carried out at 120. If there is no power present, the sensor 16 is switched to a low power mode, as shown at 122, which causes the LED 22 to be powered down. If power is present, the sensor controller 74 carries out a battery state determination at 124. If the sensor controller 74 determines that the batteries 40, 42 are not fully charged, the sensor controller 74 places the sensor 16 into a charging configuration 126, which causes the LED 22 to be set to the colour red. Once the batteries 40, 42 have been fully charged, the sensor controller 74 causes the LED 22 to be set to the colour green.

If the sensor controller 74 determines, at 118, that a plug is not inserted into the power adapter input 24, the sensor 16 is placed in an operating configuration, which causes the LED 22 to be set to a purple colour 130. In this regard, it is to be noted that the sensor controller 74 periodically performs a charging determination procedure as shown, for example, at 136 and 146 in FIG. 7. If the sensor controller 74 determines that a plug has been inserted into the power adapter 24, i.e. that the sensor 16 has been returned to its receptacle 17 in the case 12, the sensor controller 74 re-initiates the charging determination procedure, as shown at 134, 150.

The unique identifier stored in the sensor storage module 76 is contained within a generic attributes (GATT) file. Within the GATT file there are a number of unique user identifiers (UUIDs) that are associated with the pressure sensor 16. One of these UUIDs is a master UUID which provides a general indication of the presence of the sensor 16. Within the master UUID, there is at least one sub-UUID that may describe other characteristics of the sensor 16. One of these characteristics may be a unique serial number. In this embodiment, the serial number can be located in any place among the at least one sub-UUID that make up the master UUID within the GATT file.

The serial number is 16 bytes in length and is randomly generated. In this embodiment, 13 bytes of the 16 byte serial number form a product number which may be the same for the plurality of sensors 16. The remaining 3 bytes of the serial number form the unique identifier of the sensor 16. The unique identifier of the sensor 16 is represented by a six-digit hexadecimal number, such as 12FAD6, BF213F and 123456, which allows for up to 16,777,216 possible identifiers.

As described above, a representation 19 of the identifier is carried on an external surface of the housing 20 to be visible to the user. This enables the user to enter this unique identifier into the interface storage module 112 of the user interface 14 via the display 44. The representation 19 may be applied to the housing 20 in any suitable manner, for example, engraving, embossing, printing, applied via a transfer, or the like. It will also be appreciated that any indicia may be used as the unique identifier and that the unique identifier may be stored in the sensor storage module 76 in a variety of forms, including as a separate file, a separate class, a separate variable, or the like. Still further, it will be appreciated that the serial number, product number and unique identifier may be formed from any suitable number of bytes.

When the sensor 16 is in its operating configuration, the sensor controller 74 outputs, at 132, the unique identifier of the sensor 16. This enables the interface communications module 114 of the user interface 14 to read the unique identifier for determining that the unique identifier of the selected pressure sensor 16 matches one of the unique identifiers stored in the interface storage module 112 and to establish a Bluetooth connection between the sensor 16 and the user interface 14. In particular, the sensor communications module 32 provides access to the GATT file which contains the unique identifier.

The sensor controller 74 then carries out a communications link procedure, as shown at 138, to check whether a communications link between the sensor communications module 32 and the interface communications module 114 has been established. If the connection has been established, the sensor controller 74 changes the colour of the LED 22 to the colour blue 140. The user can see at a glance that a communications link has been established between the selected sensors 16 and the user interface 14.

When the system 10 is set up, a technician, using a technician-specific embodiment of the user interface 14, is able to generate calibration data, such as calibration pressure values and other related data, to instruct pressure data to be stored at the sensor storage module 76 of the sensor 16. To measure and store each of these calibration pressure values at the sensor storage module 76 of the sensor 16, the user interface 14 is used by the technician to transmit a command via the interface communications module 114 to the sensor communications module 32 to instruct the sensor controller 74 to write the current measured pressure to the sensor storage module 76 as a calibration pressure value, which forms a part of the calibration data. The sensor controller 74 performs a check for received calibration data at 142. If it is determined that calibration data has been received at 142, the sensor controller 74 writes the current measured pressure to the sensor storage module 76 as a calibration pressure value which defines a part of the calibration data.

The technician must repeat the sending of this command until a predetermined number of calibration pressure values, which together form the calibration data, is acquired by the sensor 16. In some embodiments, the sensor 16 is calibrated by the technician sending commands to the sensor 16 to measure and write eight different known calibration pressure values to the sensor storage module 76, including: 0 bar, 50 bar, 100 bar, 200 bar, 300 bar, 400 bar, 500 bar, and 600 bar. If it is determined that the calibration data has not been received at 142, a normal ten word data packet is transmitted, i.e. normal pressure sensing operation of the system 10 occurs.

In normal operational use of the sensor 16, by a regular user, the calibration data is already stored at the sensor storage module 76, and once the Bluetooth connection between the sensor 16 and the user interface 14 has been established, the sensor 16 sends measured pressure data to the user interface 14 at 144, as measured by the pressure transducer 18 of the sensor 16.

In some embodiments, the pressure data transmitted by the sensor 16 to the user interface 14 at 144 is a packet of data. In further embodiments, the packet of data contains ten words of information, each word being in the form of a 16-bit word. The first eight words of the ten words contain the eight most recent measured pressures of the sensor 16, with each of these eight words corresponding to one measured pressure. In particular, the first word contains the current pressure reading, the second word contains the previous pressure reading, and so on. In this way, the sensor 16 transmits the current pressure reading along with a seven pressure reading history to the user interface 14 for each iteration of 144, which is saved in the interface storage module 112. This method of data tracking is advantageous due to the nature of Bluetooth communication which functions by transmitting packets of data, which can occasionally be lost during a transfer. If a packet of data is lost, the saved pressure history in the interface storage module 112 from the most recent successful data packet transfer is used to recover any lost data, by selecting the most recent pressure data value available in the saved pressure history as the current pressure reading to display to a user.

One of the ten words of information, typically the ninth word, contains a pointer to the eight calibration pressure values being transmitted from the sensor 16 to the user interface 14. The pointer has a length or modulus of eight for cycling between integers 0 to 7, each integer corresponding to one of the eight calibration pressure values, and to return to 0. The last of the ten words of information contains the calibration data stored in the sensor storage module 76, which is to be transmitted to the user interface 14 for calibration of the transmitted pressure measurement values, which is performed at the user interface 14. Performing the calibration at the user interface 14 allows for easier updates to be applied to the system 10, by having to only update the user interface 14, rather than updating the entire system including the sensors 16. It will be appreciated that the data contained as words within the data packet may be in any particular order.

When the system 10 is initialised and the pressure sensor 16 is mounted to an item for measuring pressure of the item, the calibration pressure values are transmitted from the sensor 16 to the user interface 14 as eight separate packets of data, which may take approximately two seconds to complete. Once this initialisation has completed, the user interface 14 will begin displaying measured pressure data to the user which has been calibrated at the user interface 14 using the received eight calibration pressure values.

In some embodiments, the one of the ten words containing the pointer may also contain a voltage representation in the form of an 8-bit number, with the pointer also being represented as an 8-bit number, which together form one of the 16-bit “words” being transmitted to the user interface 14. This voltage representation is a measurement of the voltage from the voltage power supply pin of the sensor controller 74, which should provide an expected +2.5 V digital as shown in FIG. 5. The sensor controller 74 includes a further analog to digital converter (not shown) which is used to measure the voltage of the sensor controller 74 and convert this voltage to the 8-bit voltage representation number to be sent as part of one of the 10 words of the packet of data being transmitted to the user interface 14. The power supply voltage of the sensor controller 74 is measured and sent to the user interface 14, since the voltage delivered by the rechargeable batteries 40, 42 to the sensor controller 74 decreases over time, and will eventually decrease to a point below which the analog to digital converter 84 and the pressure transducer 82 will not operate accurately, which may result in errors in the pressure data being transmitted to the user interface 14.

The rechargeable batteries 40, 42 deliver voltage to the voltage regulator circuit 68 at a nominal +2.4 V, which is lower than the actual output voltage of the voltage regulator circuit 68 of +2.5 V digital, therefore the maximum output voltage of the voltage regulator circuit 68 is +2.5 V digital. The voltage from the rechargeable batteries 40, 42 is also delivered to the voltage boosting circuit 70, with the voltage boosting circuit 70 outputting +5.0V analog and +3.3V analog to power the pressure transducer 82 and the analog to digital converter 84. Therefore, as the input voltage from the rechargeable batteries 40, 42 to the voltage regulator circuit 68 falls, the output voltage of the voltage regulator circuit 68 will also fall from the expected +2.5 V digital.

The analog to digital converter within the sensor controller 74 allows the sensor controller 74 to monitor the +2.5 V digital voltage and transmit the measured voltage as the 8 bit byte within the 10 word data packet as described above. The measured +2.5 V digital is also a representation of the input voltage from the two rechargeable batteries 40, 42. The voltage from the batteries 40, 42 is also fed to the booster circuit 70 which creates the analog voltages used by the pressure transducer 82 and the analog to digital converter 84. Therefore, any unexpected voltages of the system 10 may be monitored at the sensor controller 74. Specifically, measuring the voltage at the sensor controller 74 and ensuring that the measured voltage is within the +2.5 V specification, indicates that the analog to digital converter 84 and the pressure transducer 82 are functioning correctly. If this measured voltage, as converted to the voltage representation contained within the packet of data sent to the user interface 14, is out of the +2.5 V specification, the relevant connector indication 50, 52, 54, 56 of the user interface 14 will, instead of displaying the pressure value for the relevant sensor 16, display “Low Battery” to indicate to the user that the rechargeable batteries 40, 42 must either be charged or replaced for accurate pressure measurements to continue to be displayed.

Due to the previously mentioned nature of Bluetooth connections, a significant delay between the connection being lost and the user realising that this has occurred, can, for example, lead the user to believe that the pressure being measured using a particular sensor 16 is remaining constant and safe, when in fact the pressure may have risen to a dangerous level after communication was lost. Due to this, the packets of data being sent from the sensor 16 to the user interface 14 via Bluetooth are monitored, such that each time a packet of data is transmitted by the sensor 16, a software timer (not shown) of the interface controller 110 for that particular sensor 16 is reset. The interface controller 110 also continuously monitors the software timer for each sensor 16 and, if its value increases to a particular time threshold, for example, two seconds, a visual indication will be sent to the user interface 14 to indicate to the user that the pressure value of the sensor 16 has not been updated for two seconds. This indication may be, for example, altering a colour of the text of the displayed pressure on the connector indications 50, 52, 54, 56 of the user interface 14 from a regular operative colour to an error state colour, for example, from white to grey. A further visual indication may be provided on the user interface 14 if the Bluetooth connection has been lost for a longer period of time, for example, ten seconds. This further visual indication may be in the form of grey dashes being displayed at the relevant connector indication/s 50, 52, 54, 56 instead of text. Additional visual indications on the user interface 14 may include messages such as “connected” (FIG. 4) and “not connected” to increase the likelihood of the user realising that one or more of the sensors 16 may be displaying an incorrect reading due to the Bluetooth connection being lost.

Referring now to FIG. 8, the operation of the user interface 14 is described in greater detail. When the user interface 14 is switched on, a splash screen 164 is displayed on the display 44 which then transitions to a setup menu 166. The setup menu includes a ‘COMMS’ radio button 168 which then displays each of the sensors associated with that user interface on a display screen 174. Each sensor 16 is displayed with its associated colour of red, yellow, green or blue on the screen 174. The user can then select and edit the unique identifier and store it in the library of unique identifiers in the interface storage module 112 corresponding to one or more of the plurality of sensors 16. This procedure will be carried out when new sensors 16 are paired with the user interface 14. Once the unique identifier has been edited, the user operates a ‘DONE’ radio button 180 to store the edited unique identifier in the library of unique identifiers contained within the interface storage module 112, and then returns to the setup menu 166.

In the setup menu 166, sensor connector radio buttons 50, 52, 54, 56 are displayed, together with a connection status. Each of the radio buttons 50, 52, 54, 56 has the relevant sensor colour associated with it.

In addition, a ‘TEST’ radio button 170 and a ‘UNIT’ radio button 172 are displayed in the setup menu 166. The ‘UNIT’ button 172 allows the user to change the units in which the pressure is to be measured via a unit display window 176.

When the user operates the ‘TEST’ button 170, a Pressure Sensor Display menu 154 is displayed on the display 44 of the user interface 14. The pressure sensor display menu 154 is associated with one of the sensors selected via the relevant connector radio buttons 50, 52, 54, 56. Once the pressure sensor display menu 154 is displayed, this allows the user to access the RESET radio button 49, a MINIMUM radio button 156, a MAXIMUM radio button 158, the BACK radio button 47 and an EDIT SENSOR NAME radio button 162. In this embodiment, the Min/Max navigation button 48 is separated into the MINIMUM button 156 and the MAXIMUM button 158.

Operating the RESET radio button 49 resets a minimum and maximum pressure to a currently measured pressure which is displayed on the display 44. Operating the MINIMUM radio button 156 and the MAXIMUM radio button 158 display, respectively, the minimum and maximum pressures measured by the sensor 16 and received by the user interface 14 since the pressing of the RESET radio button 49. When the user operates, the BACK radio button 47, the display reverts to the setup menu 166.

Operating the EDIT SENSOR NAME radio button 162 opens an Edit Sensor Name menu 152. This enables the user to edit a name of the sensor 16, for example, to assign a purpose to the sensor 16. Once completed, the user operates a DONE radio button 160 within the menu 152 to store the edited name of the sensor 16 in the interface storage module 112 and returns to the Pressure Sensor Display menu 154.

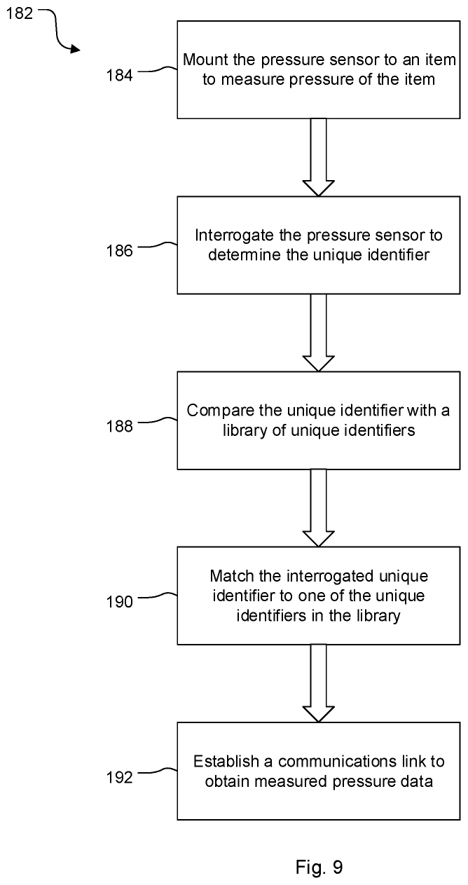

Referring to FIG. 9 of the drawings, a method of testing pressure 182 includes, at 184, mounting a pressure sensor 16 to an item, the pressure of which is to be measured. The system 10 is intended particularly for use in the mining/tracking/machinery industry to measure high oil pressures such as in hydraulic lines of earthmoving machinery, etc. Applications include measuring oil pressure in hydraulic brake lines, hydraulic supply lines to hydraulic cylinders, or the like.

Thus, the user selects the appropriate sensor 16, which may have been labelled for a particular purpose, for example, measuring pressure in a hydraulic brake line and attaches it to an oil pressure sensing port (not shown) on the hydraulic brake line.

The pressure sensor 16 is configured to measure pressure and convert the measured pressure into pressure data. As described above, the pressure sensor 16 has the unique identifier associated with it, the unique identifier being electronically stored within the pressure sensor 16 and being represented 19 on an external surface of the pressure sensor 16. The method further includes interrogating, at 186, the mounted pressure sensor 16 using the user interface 14 to determine the unique identifier of the pressure sensor 16. The user interface 14 communicates wirelessly with the pressure sensor 16 via the Bluetooth protocol.

Once the identity data have been received from the pressure sensor by the user interface 14, the user interface controller 110, at 188, compares the unique identifier of the pressure sensor 16 with the library of unique identifiers stored in the storage module 112 of the user interface 14. As shown at 190, the user interface controller 110 then conduct a matching procedure to determine if the unique identifier of the interrogated pressure sensor 16 matches one of the unique identifiers in the library of unique identifiers stored in the storage module 112 of the user interface 14. If there is a match, the method further comprises establishing a communications link to obtain the measured pressure data from the interrogated pressure sensor 16 and displays on the display 44 of the user interface 14 as shown at 192.

A plurality of pressure sensors 16 is associated with the user interface 14, with each pressure sensor having its own unique identifier stored electronically. To achieve this, the user stores each of the unique identifiers of each pressure sensor 16 in the interface storage module 112 of the user interface 14 by accessing the setup menu 166, then the selection window 174 and the editing window 178 in which the unique identifier can be entered. To store each of the unique identifiers of each pressure sensor 16 in the interface storage module 112 of the user interface 14, a user also checks the representation 19 of the unique identifier carried on the external surface of the pressure sensor 16 to ensure that the correct sensor identity data are stored in the storage module 112 of the user interface 14.

The method further includes displaying a minimum pressure and a maximum pressure measured by each pressure sensor 16 on the display 44 of the user interface 14.

When not in use, the sensors 16 and the user interface 14 are stored in the case 12. The case 12 has an internal power source (not shown) and the case 12 provides electrical power to the sensors 16 and the user interface 14 to maintain the charge of the batteries of the sensors 16 and the user interface 14.

Advantageously, each sensor 16 has its unique identifier which allows the user to connect the interface 14 to a particular sensor 16, rather than selecting a sensor from a list of available sensors or automatically connecting the interface 14 to the nearest sensor 16. By providing a secure, repeatable system and method of connecting each sensor 16 to the interface 14, the likelihood of the user being confused as to which sensor 16 corresponds to the pressure being displayed on the display 44 is significantly reduced. By establishing a communications link between each sensor 16 and the interface 14, the user is able to read the pressure being measured by each sensor 16 from the item that each sensor is mounted to, while the user remains at a safe distance from the item and/or shielded from a potentially dangerous situation by protective covers, or the like, of the machinery. In addition, the user interface 14 can only communicate with those pressure sensors 16 whose unique identifiers have been stored in the storage module 112 of the user interface 14. This reduces the likelihood of sensors associated with other systems inadvertently communicating with the user face 14 of the system 10.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A pressure testing system, comprising:
a plurality of pressure sensors, each pressure sensor, comprising:
a housing mountable to an item, the pressure of which is to be measured;
a pressure transducer arranged in the housing to measure pressure and convert the measured pressure to pressure data;
a sensor storage module arranged in the housing, the sensor storage module containing a unique identifier of the pressure sensor;
a sensor communications module in communication with the pressure transducer for transmitting identifier data and the pressure data; and
a representation of the unique identifier carried on an external surface of the housing; and
a user interface, comprising:
an interface storage module containing a library of the unique identifiers of the pressure sensors associated with the user interface;
an interface communications module which communicates wirelessly with the sensor communications module of each pressure sensor for receiving the transmitted identifier data and pressure data from a selected one of the pressure sensors; and
a controller which communicates with each pressure sensor via the interface communications module and the sensor communications module of the selected sensor for identifying the selected pressure sensor and for confirming that that pressure sensor is associated with the user interface by matching the unique identifiers stored in the sensor storage module of the selected pressure sensor and in the interface storage module of the user interface.

2. The system according to claim 1, wherein each pressure sensor further comprises a sensor controller for controlling operation of the sensor communications module to send the pressure data after a connection has been established with the interface communications module.

3. The system according to claim 2, wherein the sensor communications module is operable, by the sensor controller, to provide access to the unique identifier of the sensor storage module for the interface communications module to read the unique identifier for determining that the unique identifier of the selected pressure sensor matches one of the unique identifiers stored in the interface storage module to establish the connection with the sensor communications module.

4. The system according to claim 3, wherein the controller of the user interface is configured to operate the interface communications module to read the unique identifier of the sensor storage module of the selected pressure sensor to determine that the unique identifier of the selected pressure sensor matches one of the unique identifiers stored in the interface storage module to establish the connection with the sensor communications module.

5. The system according to claim 3 or claim 4, wherein each pressure sensor further comprises an annunciator controlled by the sensor controller for indicating operational status of the pressure sensor.

6. The system according to any one of the preceding claims, which uses a Bluetooth protocol as a communications protocol between the each sensor communications module of each pressure sensor and the user interface, the sensor communications module thus being a Bluetooth module and the interface communications module also being a Bluetooth module.

7. The system according to any one of the preceding claims, wherein the user interface further comprises a display on which information is displayed to a user.

8. The system according to any one of the preceding claims which includes a carrier defining a plurality of receptacles for receiving the pressure sensors and the user interface, each pressure sensor and the user interface being received in their respective receptacles.

9. The system according to claim 8 in which the carrier houses a store of electrical power and in which each receptacle has an electrical terminal associated with it for supplying electrical power to each pressure sensor and the user interface when the pressure sensors and the user interface are contained in their respective receptacles.

10. A method of testing pressure, the method comprising:
mounting a pressure sensor to an item, the pressure of which is to be measured, the pressure sensor being configured to measure pressure and convert the measured pressure into pressure data and the pressure sensor having a unique identifier associated with it, the unique identifier being electronically stored within the pressure sensor and being represented on an external surface of the pressure sensor;
interrogating the mounted pressure sensor using a user interface which communicates wirelessly with the pressure sensor, the user interface interrogating the pressure sensor to determine its unique identifier;
comparing the unique identifier of the pressure sensor with a library of unique identifiers stored in a storage module of the user interface; and
if the unique identifier of the interrogated pressure sensor matches one of the unique identifiers in the library of the user interface, establishing a communications link to obtain the measured pressure data from the interrogated pressure sensor.

11. The method according to claim 10 which comprises associating a plurality of pressure sensors with the user interface, each pressure sensor having its own unique identifier stored electronically and a representation of which is carried on the external surface of the pressure sensor, the method further comprising storing each of the unique identifiers in an interface storage module of the user interface.

12. The method according to claim 11 which includes selecting which of the pressure sensors to use and, prior to mounting any one of the pressure sensors to the item, checking that the representation of the unique identifier of each selected pressure sensor matches the unique identifier stored in the interface storage module of the user interface.

13. The method according to claim 12 which includes displaying the pressure measured by each pressure sensor on a display of the user interface.

14. The method according to claim 13 which includes displaying a minimum pressure and a maximum pressure measured by each pressure sensor on the display of the user interface.

15. The method according to any one of claims 11 to 14 which comprises storing the sensors and the user interface in a carrier and providing electrical power to the sensors and the user interface via the carrier.

16. The method according to any one of claims 11 to 15 which comprises indicating an operational status of each pressure sensor via an annunciator carried by the pressure sensor.

17. The method according to any one of claims 11 to 16, wherein each pressure sensor and the user interface communicate with each other via a Bluetooth protocol.

18. A pressure sensor for use with the pressure testing method of any one of claims 10 to 17, the pressure sensor comprising:
a housing mountable to an item, the pressure of which is to be measured;
a pressure transducer arranged in the housing to measure pressure and convert the measured pressure to pressure data;
a sensor storage module arranged in the housing, the sensor storage module containing a unique identifier of the pressure sensor;
a sensor communications module in communication with the pressure transducer for transmitting identifier data and the pressure data; and
a representation of the unique identifier carried on an external surface of the housing.

19. A user interface for use with the pressure testing method of any one of claims 10 to 17, the user interface comprising:
an interface storage module containing a library of unique identifier of each a plurality of pressure sensors associated with the user interface;
an interface communications module which communicates wirelessly with the sensor communications module of each pressure sensor for receiving transmitted identifier data and pressure data from a selected one of the pressure sensors; and
a controller which communicates with each pressure sensor via the interface communications module and the sensor communications module of the selected sensor for identifying the selected pressure sensor and for confirming that that pressure sensor is associated with the user interface by matching the unique identifiers stored in the sensor storage module of the selected pressure sensor and in the interface storage module of the user interface.
